(19) United States
(12) Patent Application Publication
(10) Pub. No.: US 2006/0143633 A1
(43) Pub. Date: Jun. 29, 2006

(54) Optical pick-up apparatus and optical disk apparatus

(75) Inventor: Toru Washiyama, Kawasaki-City (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Toshiba Samsung Storage Technology Corporation, Kawasaki-city (JP)

(21) Appl. No.: 11/318,685

(22) Filed: Dec. 28, 2005

(30) Foreign Application Priority Data
Dec. 28, 2004 (JP) 2004-381933
Sep. 30, 2005 (JP) 2005-287532

(51) Int. Cl. G11B 33/14

(52) U.S. Cl. 720/649

(57) ABSTRACT

An optical pick-up apparatus that irradiates a disk with laser light emitted from a laser light source and uses a photodetector to receive the laser light reflected by the disk to thereby perform recording/reproduction onto/from the disk, comprises: a laser diode driver that drives the laser light source; an upper cover that serves as a heat radiation means for radiating heat generated by the laser diode driver; and an optical base that serves as a heat radiation means for radiating heat generated by the laser light source and photodetector.

### CROSS REFERENCE TO RELATED APPLICATIONS

This application is based upon and claims the benefit of priority from the Japanese Patent Application JP 2004-381933 filed on Dec. 28, 2004, and Japanese Patent Application JP 2005-287532 filed on Sep. 30, 2005, the entire contents of which are incorporated herein by reference.

### BACKGROUND OF THE INVENTION

1. Field of the Invention

The present invention relates to an optical disk apparatus and more particularly to a configuration of an optical pick-up apparatus having a plurality of semiconductor laser light sources.

2. Description of the Related Art

A laser diode driver (LDD) for driving a laser light source is mounted in an optical pick-up apparatus, and a configuration in which a heat radiation rib for radiating heat transferred to an optical base is provided as a countermeasure against the problem of heat generated in the laser diode driver is known (refer to, for example, Jpn. Pat. Appln. Laid-Open Publication No. 2004-220642).

This configuration is effective if only the laser diode driver is mounted on the optical base. However, if many heat generation sources such as a laser light source or a photodetector are mounted on the optical base, the optical base is thermally saturated, making it impossible to radiate heat.

If it is possible to provide a sufficient space between heat generation sources, or it is possible to ensure a high heat radiation capability of the optical base, such heat can be ignored. However, in a small and flat type pickup apparatus designed to be mounted in a lap-top (PC), it is difficult to provide a sufficient space between heat generation sources or ensure a high heat radiation capability of the optical base. In a three-wavelength-compatible pickup apparatus, the number of heat generation sources is further increased to limit the size of a space that can be used for taking the above measures. As a result, it becomes more difficult to satisfy the above condition suitable for the heat radiation.

### SUMMARY OF THE INVENTION

The present invention has been made in view of the above problem related to the heat generated in a small-sized optical pick-up apparatus having many heat generation sources, and an object thereof is to provide an optical pick-up apparatus and an optical disk apparatus capable of suppressing heat generation in the laser diode driver to a minimum level.

According to a first aspect of the present invention, there is provided an optical pick-up apparatus that irradiates a disk with laser light emitted from a laser light source and uses a photodetector to receive the laser light reflected by the disk to thereby perform recording/reproduction onto/from the disk, comprising: a laser diode driver that drives the laser light source; an upper cover that serves as a heat radiation means for radiating heat generated by the laser diode driver; and an optical base that serves as a heat radiation means for radiating heat generated by the laser light source and photodetector.

According to the first aspect, the laser diode driver that uses the upper cover as a heat radiation means is not thermally influenced by the optical base, so that the heat generated by the laser diode driver can sufficiently be radiated to the atmosphere through the upper cover. Further, a heat radiation area serving as a heat radiation means for radiating the heat generated by the laser diode driver can be ensured by the upper cover. As a result, the laser diode driver can be maintained at an operation-guaranteed temperature. Further, the laser diode driver that uses the upper cover as a heat radiation means does not give thermal influence to the optical base to prevent the optical base from being thermally saturated, so that the heat generated by the laser light source and photodetector that use the optical base as a heat radiation means can sufficiently be radiated. As a result, a total heat radiation area in the apparatus is increased and thereby heat radiation effect of the entire apparatus can be improved. The surface area of the upper cover can appropriately be set, so that it is possible to adjust and set heat radiation effect of the laser diode driver that uses the upper cover as a heat radiation means.

According to a second aspect of the present invention, in the first aspect of the optical pick-up apparatus, the laser diode driver is thermally coupled to the upper cover and is thermally isolated from the optical base. According to the second aspect, the laser diode driver is less thermally influenced by the optical base, and the heat generated by the laser diode driver can be certainly transmitted to the upper cover and radiated to the atmosphere through the upper cover.

According to a third aspect of the present invention, in the first aspect of the optical pick-up apparatus of the invention, the laser light source and photodetector are thermally coupled to the optical base. According to the third aspect, the laser diode driver that uses the upper cover as a heat radiation means does not give thermal influence to the optical base to prevent the optical base from being thermally saturated. As a result, the heat generated by the laser light source and photodetector can certainly be transmitted to the optical base and radiated to the atmosphere through the optical base.

According to a fourth aspect of the present invention, in the second aspect of the optical pick-up apparatus of the invention, the upper cover is made of a highly heat conductive material and includes a cover for heat generation source that radiates heat generated by the laser diode driver and an entire cover that radiates heat generated from the entire optical pick-up apparatus. According to the fourth aspect, it is possible to control heat radiation effect of the upper cover by appropriately setting the surface area of the cover for heat generation source relative to the entire cover, and the material and thickness of the same.

According to a fifth aspect of the present invention, in the second aspect of the optical pick-up apparatus of the invention, the upper cover has a cross-section formed into U-like shape that surrounds the laser diode driver and a printed circuit on which the laser diode driver is mounted. According to the fifth aspect, it is possible to avoid the swelling of the upper cover.

According to a sixth aspect of the present invention, in the second aspect of the optical pick-up apparatus of the invention, the laser diode driver and optical base are thermally isolated from each other by a low heat conductive backing board. According to the sixth aspect, the respective heats generated by the laser diode driver and the optical base, are not transmitted to each other.

According to a seventh aspect of the present invention, in the fourth aspect of the optical pick-up apparatus of the invention, the cover for heat generation source has convex and concave portions on its surface. According to the seventh aspect, it is possible to ensure heat radiation effect.

According to another aspect of the present invention, in the first aspect of the optical pick-up apparatus of the invention, the laser diode driver and upper cover are thermally coupled to each other through a heat transfer material or heat dissipation agent. According to this aspect, the heat generated by the laser diode driver can certainly be transmitted to the upper cover and radiated to the atmosphere through the upper cover.

According to still another aspect of the present invention, in the first aspect of the optical pick-up apparatus, the laser diode driver is disposed at the position spaced apart from the laser light source and photodetector. According to this aspect, heat radiation effect of the laser diode driver can be ensured by means of the upper cover without being thermally influenced by the laser light source and photodetector that use the optical base as a heat radiation means. As a result, the laser diode driver can be maintained at an operation-guaranteed temperature.

According to still another aspect of the present invention, there is provided an optical disk apparatus including an optical pick-up apparatus including an optical pick-up apparatus that forms a laser diode beam spot on a recording medium to perform recording/reproduction of information, the optical pick-up apparatus being the optical pick-up apparatus according to the above aspects.

According to the aspect of the present invention, an optical pick-up apparatus and optical disk apparatus capable of suppressing heat generation in the laser diode driver to a minimum level.

### BRIEF DESCRIPTION OF THE DRAWINGS

FIG. 1A is a perspective view showing a configuration of an optical pick-up apparatus according to an embodiment of the present invention as viewed from the front side thereof through a partly cut-out upper cover;

FIG. 1B is a perspective view showing the optical pick-up apparatus according to the embodiment of the present invention as viewed from the rear side;

FIG. 2 is a perspective view showing the optical pick-up apparatus according to the embodiment of the present invention with the front surface thereof covered by the upper cover;

FIG. 3 is a cross-sectional view taken along A-A line in FIG. 2;

FIG. 4 shows a configuration according to another embodiment of the present invention;

FIG. 5 is a cross-sectional view taken along B-B line in FIG. 4;

FIG. 6 is a view showing the shape and structure of an upper cover for LDD in FIG. 4;

FIG. 7 is a cross-sectional view taken along the line C-C in FIG. 6;

FIG. 8 is a perspective view showing a configuration according to still another embodiment of the present invention;

FIG. 9 is a cross-sectional view taken along D-D line in FIG. 8; and

FIG. 10 is a view as viewed in the direction denoted by the arrow E in FIG. 9.

### DETAILED DESCRIPTION OF THE PREFERRED EMBODIMENTS

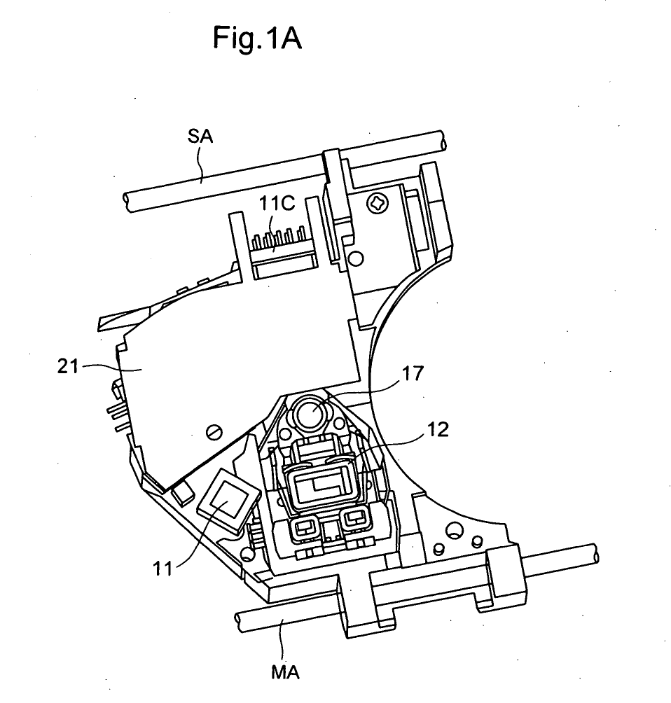

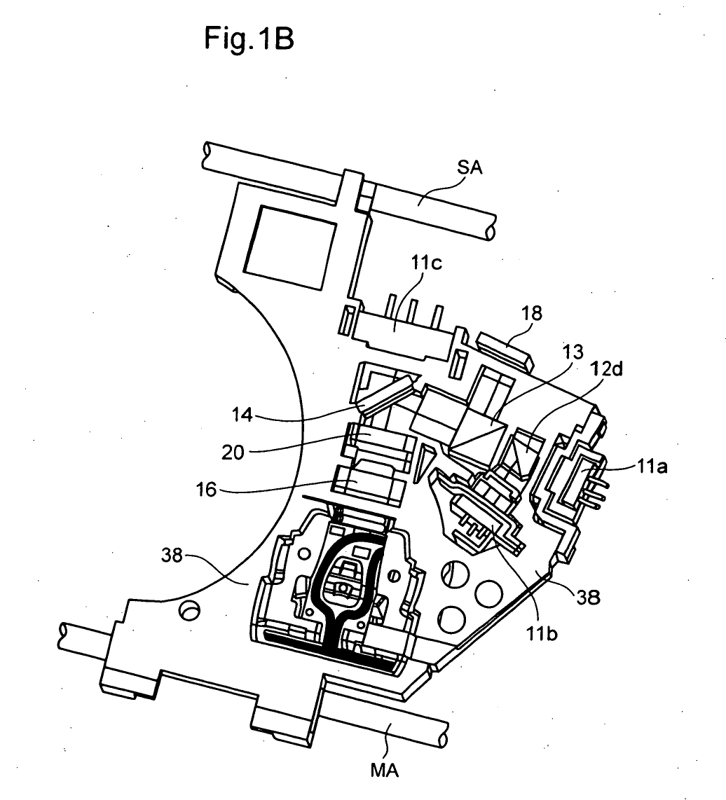

Embodiments of the present invention will be described below with reference to the accompanying drawings. FIGS. 1 to 3 show a configuration according to an embodiment of the present invention. In this embodiment, heat generated in a laser diode driver 11 that drives laser diodes 11a, 11b, and 11c serving as a laser light source is not allowed to escape to an optical base 38 provided below the laser diode driver 11, but is allowed to be released through an upper cover 21.

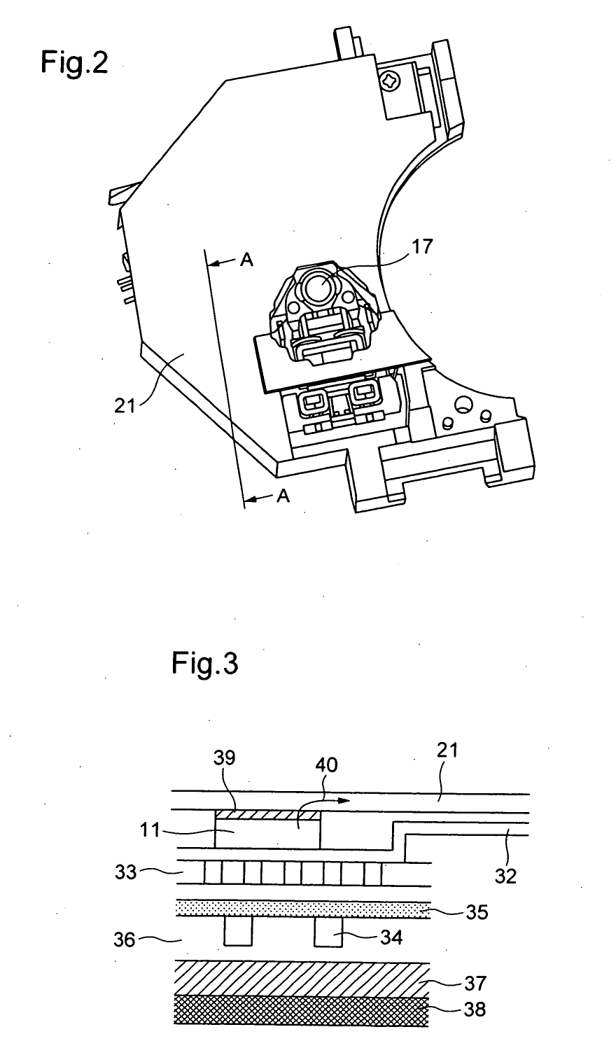

FIG. 1A is a perspective view showing a configuration of an optical pick-up apparatus as viewed from the front side thereof through a partly cut-out upper cover 21, and this shows a configuration around a laser diode driver (hereinafter, referred to as merely “LDD”) 11. FIG. 1B is a perspective view showing the same portion as that shown in FIG. 1A as viewed from the rear side. FIG. 2 is a perspective view showing the configuration around a laser diode driver with the front surface covered by the upper cover 21. FIG. 3 is a cross-sectional view taken along A-A line in FIG. 2.

The optical pick-up apparatus irradiates a disk serving as a recording medium with laser light emitted from the laser diodes 11a, 11b, and 11c which are laser light sources.

Laser light for HDDVD emitted from the laser diode 11a is passed through a first dichroic element 12d and a polarizing beam splitter 13 and reflected by a second dichroic element 14. The reflected light is then passed through a collimate lens 20, reflected by a raising mirror 16, and transmitted through an objective lens 17 to form a beam spot on a disk. Laser light for DVD emitted from the laser diode 11b is reflected by the first dichroic element 12d, passed through the polarizing beam splitter 13, reflected by the second dichroic element 14. The reflected light is then passed through the collimate lens 20, reflected by the raising mirror 16, and transmitted through the objective lens 17 to form a beam spot on a disk. Laser light for CD emitted from the laser diode 11c is passed through the second dichroic element 14 and collimate lens 20, reflected by the raising mirror 16, and transmitted through the objective lens 17 to form a beam spot on a disk.

The laser light for HDDVD, DVD, and CD irradiated onto a disk is reflected by the disk. The laser light for HDDVD and DVD is received by a photodetector 18, and laser light for CD is received by another photodetector (not shown).

As described above, the optical pick-up apparatus irradiates a disk with laser light emitted from the laser light source to form a beam spot on the disk and receives light reflected by the disk with the photodetector 18 to thereby perform recording/reproduction of information onto/from the disk. The optical pick-up apparatus is incorporated in an optical disk apparatus.

The laser diodes 11a, 11b, 11c, and photodetector 18 that constitute an optical system and optical axis system are disposed on an optical base 38 with accurate positional relationship kept with other components constituting the optical system and optical axis system. In this positional relationship, heat generated by the laser diodes 11a, 11b, 11c, and photodetector 18 is allowed to be escape to the optical base 38.

As shown in FIG. 1A, the LDD 11 is disposed at the outer periphery side of the area in which an actuator 12 is positioned so as to be spaced apart from the components of optical system and optical axis system. That is, the LDD 11 can be spaced apart from another heat generation sources such as the laser diodes 11a, 11b, 11c and photodetector 18, so that heat radiation effect of the LDD 11 can effectively be developed. In particular, in flat type optical pick-up apparatus using three wavelengths corresponding to CD, DVD, HDDVD, it is preferable that the LDD 11 be disposed at the outer periphery side of the area in which an actuator 12 is positioned.

Further, it is preferable in terms of heat radiation effect that the LDD 11 be disposed at the position out of the optical-axis. In this case, concentration of heat generation sources can be avoided.

As shown in FIG. 1A, the optical pick-up apparatus is guided by a main axis MA directly driven by a drive source and a sub axis SA provided parallel to the main axis. It is possible to dispose the LDD 11 at the portion on the inner periphery side of the area in which the actuator 12 is positioned, the portion being on the sub axis SA side. However, this arrangement is not preferable in terms of electrical characteristics because the distances between the LDD 11 and laser light sources, that is, laser diodes 11a, 11b are increased.

As shown in FIG. 3, the LDD 11 is mounted on a printed circuit, such as a flexible printed circuit (hereinafter referred to as “FPC”) 32 serving as a heat shielding board. Provided under the FPC 32 is a backing board 33 made of a relatively low heat conductive material. Further, an FPC 35 on which components 34 are mounted is provided under the backing board 33. A predetermined space 36 is provided under the FPC 35. Finally, a radiator plate 37 and optical base 38 for radiating heat generated in other components are provided under the space 36. Although not shown, the laser diodes 11a, 11b, 11c and photodetector 18 are disposed not immediately under the LDD 11, but disposed at the positions spaced apart from the position of the LDD 11 on the optical base 38 with predetermined distances so as to contact the radiator plate 37 and optical base 38 made of highly heat conductive materials. This arrangement allows heat generated by the laser diodes 11a, 11b, 11c and photodetector 18 to be radiated.

The LDD 11 is covered by the upper cover 21 made of a highly heat conductive material. The LDD 11 and upper cover 21 directly contact with each other. Alternatively, a heat transfer material or heat dissipation agent such as heat-radiation grease 39 may be interposed between the LDD 11 and upper cover 21. That is, the LDD 11 and upper cover 21 are thermally coupled to each other.

Heat generated by the LDD 11 is hard to be transmitted downward due to existence of the FPC 32, backing board 33, and predetermined space 36 but is radiated upward through the heat-radiation grease 39 and the upper cover 21 to the atmosphere, as denoted by the arrow 40. That is, the LDD 11 is thermally coupled to a package mounted on the upper cover 21 by contacting the upper cover 21 directly or through a heat transfer material or heat dissipation agent. The folded FPC 32, backing board 33 and predetermined space 36 exist between the LDD 11 and optical base 38, and the size of the ground contact area of the LDD 11 is reduced, which increases heat resistance to allow the LDD 11 and optical base 38 are thermally isolated from each other. A highly heat conductive material, such as copper is used as a material of the upper cover 21. Holes or the like are not formed on the surface of the cover 21 so as not to block heat circulation.

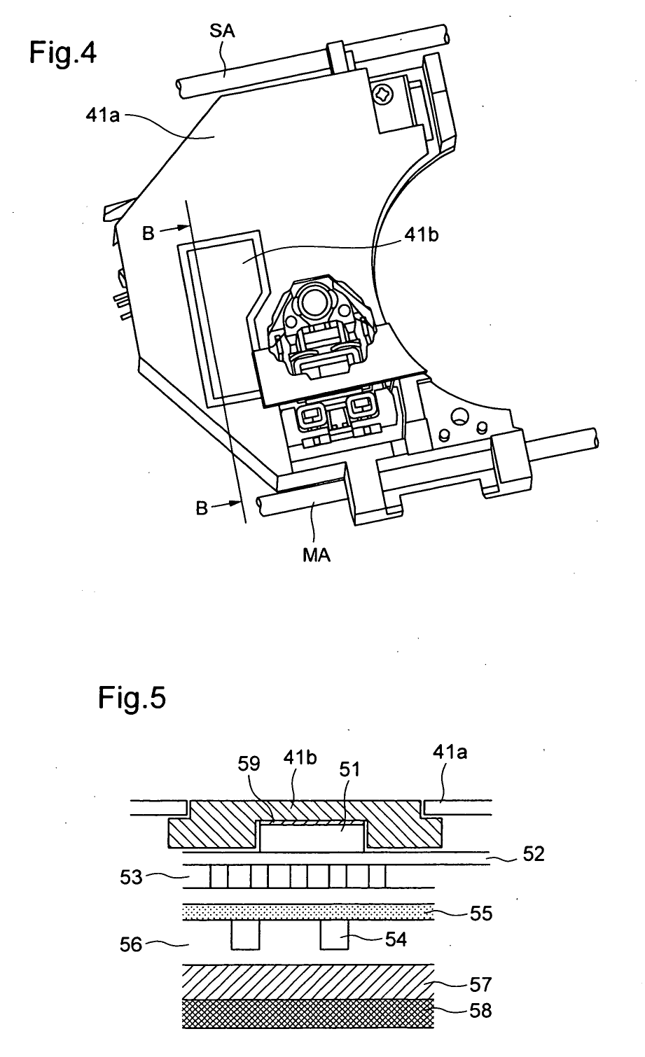

In this embodiment of the present invention, the heat generated by the LDD 11 is radiated upward toward the atmosphere through the upper cover 21; whereas the heat generated by the laser light sources, that is, laser diodes 11a, 11b, 11c and photodetector 18, is radiated downward toward the atmosphere through the radiator plate 37 and optical base 38. Further, the flexible circuit board 32 and backing board 33 are interposed between the LDD 11 and radiator plate 37, optical base 38, preventing the heat generated by the LDD 11 from being transmitted to the optical base 38. The backing board 33 has an inner space as shown in FIG. 4, sufficiently preventing the heat from being transmitted therethrough.

FIG. 4 shows a configuration according to another embodiment of the present invention. In the example of FIG. 4, as the upper cover 41, an upper cover 41b for LDD is provided in addition to an entire upper cover 41a. FIG. 5 shows a cross-sectional view taken along B-B line in FIG. 4. In FIG. 5, reference numeral 51 is the LDD, and numerals 52 to 59 correspond to numerals 32 to 39 in FIG. 3. This configuration prevents heat generated by the LDD 51 from being transmitted downward to the FPC 52 and backing board 53 and allows the heat to be radiated upward through the upper cover 41b for LDD.

When a highly heat conductive material, such as copper, is used as the upper cover 41b for LDD, heat radiation effect can be increased.

As described above, a part of the upper cover 41 is provided as a different member for heat radiation for the LDD 51 in order to increase heat radiation effect. In the case where the area that the upper cover 41 covers is large, when the thickness of the cover 41 is increased, space is lost and the weight thereof becomes heavy. Therefore, in general, the plate thickness of the upper cover 41 cannot be increased.

Further, if the cross sectional area of the cover 41 is small, heat cannot be circulated around the entire cover 41. Therefore, it is preferable to increase the thickness of the cover 41 within the limited range with the area that it covers. This configuration may further increase heat radiation effect, in some cases.

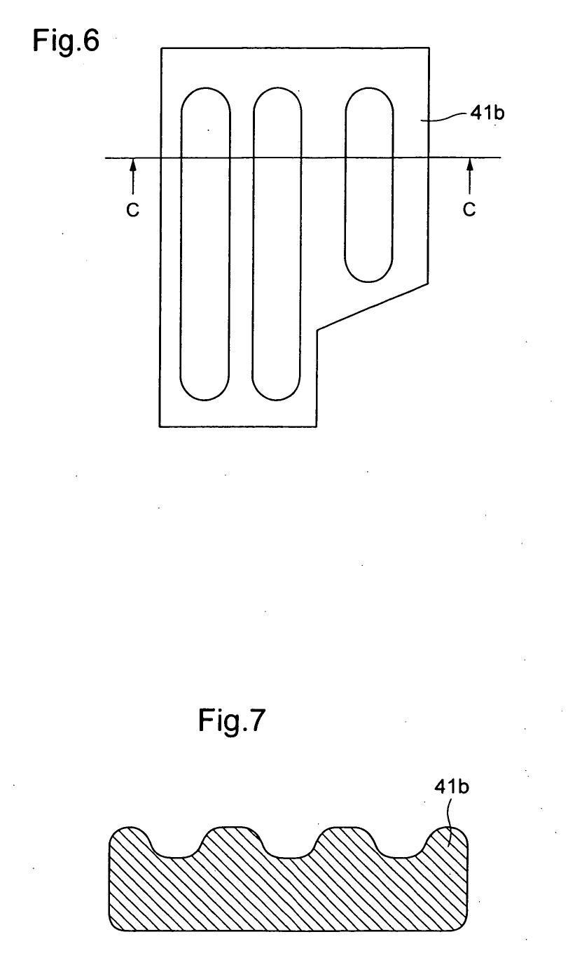

In the case where the upper cover 41b for LDD having a shape as shown in FIG. 6 can be thickened to some degree, convex and concave portions can be formed on the surface of the upper cover 41b to obtain a heat radiator fin structure as shown in FIG. 7 which shows a cross-sectional view taken along C-C line in FIG. 7. The surface area of the upper cover 41b having this configuration becomes large, thereby increasing heat radiation effect.

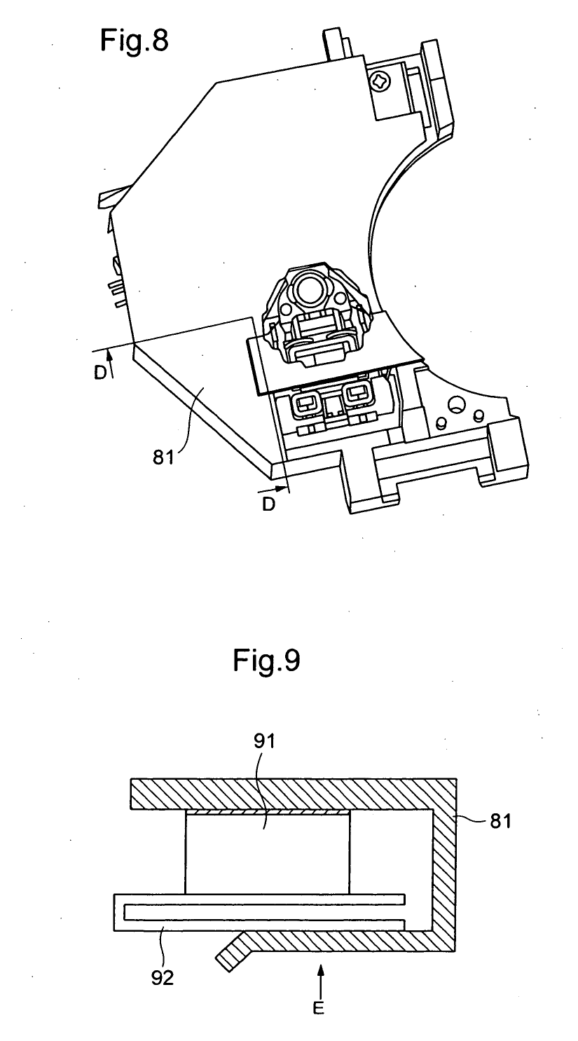

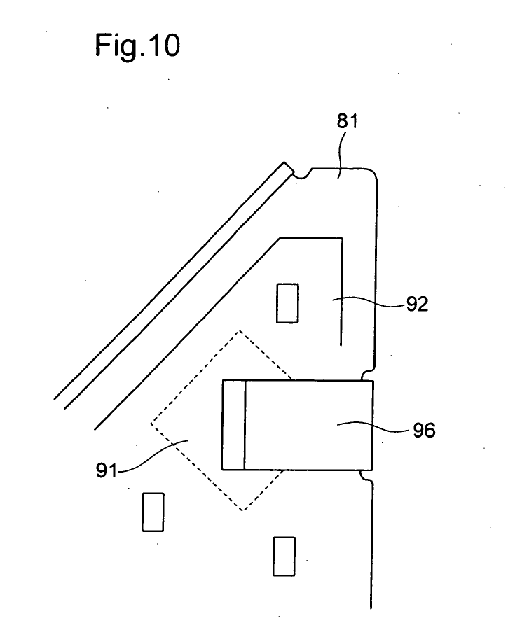

Next, still another embodiment of the present invention will be described. In this embodiment, the cross-section of the upper cover 81 is formed into U-like shape, as shown in FIG. 8. FIG. 9 is a cross-sectional view taken along D-D line in FIG. 8. In this embodiment, the upper cover 81 surrounds the LDD 91 and FPC 92. FIG. 10 is a view as viewed in the direction denoted by the arrow E in FIG. 9. The LDD 91 is surrounded by a U-like shape member 96.

In this embodiment, the upper cover 81 is formed into U-like shape and surrounds the LDD 91 and FPC 92. This configuration is effective in the case where contact pressure needs to be increased to ensure heat radiation effect, and swelling of the cover needs to be avoided.

In the following, features of the above embodiments according to the present invention will be concretely listed.

(1) The optical pick-up apparatus according to the present invention includes a laser diode driver 11 that drives laser light sources 11a, 11b, 11c, an upper cover 21 that serves as a heat radiation means for radiating hear generated by the laser diode driver 11, and an optical base 38 that serves as a heat radiation means for radiating heat generated by the laser light sources 11a, 11b, 11c, and a photodetector 18. With the above configuration, the laser diode driver 11 that uses the upper cover 21 as a heat radiation means is less thermally influenced by the optical base 38, so that the heat generated by the laser diode driver 11 can sufficiently be radiated to the atmosphere through the upper cover 21. Further, a heat radiation area serving as a heat radiation means for radiating the heat generated by the laser diode driver 11 can be ensured by the upper cover 21. As a result, the laser diode driver 11 can be maintained at an operation-guaranteed temperature. Further, the laser diode driver 11 that uses the upper cover 21 as a heat radiation means does not give thermal influence to the optical base 38 to prevent the optical base 38 from being thermally saturated, so that the heat generated by the laser light sources 11a, 11b, 11c and photodetector 18 that use the optical base 38 as a heat radiation means can sufficiently be radiated. As a result, a total heat radiation area in the apparatus is increased and thereby heat radiation effect of the entire apparatus can be improved. The surface area of the upper cover 21 can appropriately be set, so that it is possible to adjust and set heat radiation effect of the laser diode driver 11 that uses the upper cover 21 as a heat radiation means.

(2) The laser diode driver 11 is thermally coupled to the upper cover 21 and thermally isolated from the optical base 38. Thus, the laser diode driver 11 is not thermally influenced by the optical base 38, and the heat generated by the laser diode driver 11 can be certainly transmitted to the upper cover 21 and radiated to the atmosphere through the upper cover 21.

(3) The laser light sources 11a, 11b, 11c and photodetector 18 are thermally coupled to the optical base 38. On the other hand, the laser diode driver 11 that uses the upper cover 21 as a heat radiation means does not give thermal influence to the optical base 38 to prevent the optical base 38 from being thermally saturated. As a result, the heat generated by the laser light sources 11a, 11b, 11c and photodetector 18 can certainly be transmitted to the optical base 38 and radiated to the atmosphere through the optical base 38.

(4) An upper cover 41 is made of a highly heat conductive material and constituted by a cover 41b for heat generation source that radiates heat generated by the laser diode driver 51 and an entire cover 41a that radiates heat from by the entire optical pick-up apparatus. It is possible to control heat radiation effect of the upper cover 41 by appropriately setting the surface area of the cover 41b for heat generation source relative to the entire cover 41a, and the material and thickness of the same.

(5) The cover 41b for heat generation source has convex and concave portions on its surface, thereby ensuring heat radiation effect.

(6) The laser diode driver 11 and upper cover 21 are thermally coupled to each other through a heat transfer material or heat dissipation agent. Thus, the heat generated by the laser diode driver 11 can certainly be transmitted to the upper cover 21 and radiated to the atmosphere through the upper cover 21.

(7) The laser diode driver 11 is disposed at the position spaced apart from the laser light sources 11a, 11b, 11c, and photodetector 18. Thus, heat radiation effect of the laser diode driver 11 can be ensured by means of the upper cover 21 without being thermally influenced by the laser light sources 11a, 11b, 11c, and photodetector 18 that use the optical base 38 as a heat radiation means. As a result, the laser diode driver 11 can be maintained at an operation-guaranteed temperature.

(8) An upper cover 81 has a cross-section formed into U-like shape that surrounds the laser diode driver 91 and a printed circuit 92 on which the laser diode driver 91 is mounted. This configuration can avoid the swelling of the upper cover 81.

(9) The laser diode driver 11 and optical base 38 are thermally isolated from each other by a low heat backing board. As a result, the respective heats generated by the laser diode driver 11 and the optical base 38, are not transmitted to each other.

(10) Provided according to the present invention is an optical disk apparatus including an optical pick-up apparatus that forms a laser diode beam spot on a recording medium to perform recording/reproduction of information, the optical pick-up apparatus being the optical pick-up apparatus according to any one of the above (1), (2), (3), and (4).

The present invention is not limited to the above embodiments, and various modifications may be made without departing from the scope of the general inventive concept.

What is claimed is:

1. An optical pick-up apparatus that irradiates a disk with laser light emitted from a laser light source and uses a photodetector to receive the laser light reflected by the disk to thereby perform recording/reproduction onto/from the disk, comprising:
a laser diode driver that drives the laser light source;
an upper cover that serves as heat radiation means for radiating heat generated by the laser diode driver; and
an optical base that serves as heat radiation means for radiating heat generated by the laser light source and photodetector.

2. The optical pick-up apparatus according to claim 1, wherein
the laser diode driver is thermally coupled to the upper cover and is thermally isolated from the optical base.

3. The optical pick-up apparatus according to claim 1, wherein
the laser light source and photodetector are thermally coupled to the optical base.

4. The optical pick-up apparatus according to claim 2, wherein
the upper cover is made of a highly heat conductive material and includes a cover for heat generation source that radiates heat generated by the laser diode driver and an entire cover that radiates heat generated from the entire optical pick-up apparatus.

5. The optical pick-up apparatus according to claim 2, wherein
the upper cover has a cross-section formed into U-like shape that surrounds the laser diode driver and a printed circuit on which the laser diode driver is mounted.

6. The optical pick-up apparatus according to claim 2, wherein
the laser diode driver and optical base are thermally isolated from each other by a low heat conductive backing board.

7. The optical pick-up apparatus according to claim 4, wherein
the cover for heat generation source has convex and concave portions.

8. The optical pick-up apparatus according to claim 2, wherein
the laser diode driver and the upper cover are thermally coupled to each other through a heat transfer material or heat dissipation agent.

9. The optical pick-up apparatus according to claim 4, wherein
the laser diode driver and the upper cover are thermally coupled to each other through a heat transfer material or heat dissipation agent.

10. The optical pick-up apparatus according to claim 1, wherein
the laser diode driver is disposed at the position spaced apart from the laser light source and photodetector.

11. The optical pick-up apparatus according to claim 2, wherein
the laser diode driver is disposed at the position spaced apart from the laser light source and photodetector.

12. The optical pick-up apparatus according to claim 3, wherein
the laser diode driver is disposed at the position spaced apart from the laser light source and photodetector.

13. An optical disk apparatus including an optical pick-up apparatus that forms a laser diode beam spot on a recording medium to perform recording/reproduction of information, the optical pick-up apparatus being the optical pick-up apparatus as claimed in claim 1.

14. An optical disk apparatus including an optical pick-up apparatus that forms a laser diode beam spot on a recording medium to perform recording/reproduction of information, the optical pick-up apparatus being the optical pick-up apparatus as claimed in claim 2.

15. An optical disk apparatus including an optical pick-up apparatus that forms a laser diode beam spot on a recording medium to perform recording/reproduction of information, the optical pick-up apparatus being the optical pick-up apparatus as claimed in claim 3.

16. An optical disk apparatus including an optical pick-up apparatus that forms a laser diode beam spot on a recording medium to perform recording/reproduction of information, the optical pick-up apparatus being the optical pick-up apparatus as claimed in claim 4.
